(19) United States
(12) Patent Application Publication
(10) Pub. No.: US 2025/0372626 A1
(43) Pub. Date: Dec. 4, 2025

(54) COMPOSITE CATHODE ACTIVE MATERIAL FOR LITHIUM SECONDARY BATTERY WITH EXCELLENT COATING QUALITY AND METHOD OF PREPARING THE SAME

(71) Applicants: Hyundai Motor Company, Seoul (KR); Kia Corporation, Seoul (KR); Hansol Chemical Co., Ltd., Seoul (KR)

(72) Inventors: So Young Kim, Hwaseong (KR); Sang Heon Lee, Hwaseong (KR); Sang Soo Lee, Hwaseong (KR); Ho Cheol Shin, Hwaseong (KR); Wo Dum Jung, Hwaseong (KR); Geun Hyeong Shin, Hwaseong (KR); Hong Seok Min, Hwaseong (KR); Jae Young Kim, Hwaseong (KR); So Young Yoon, Jeollabuk-do (KR); Young Sung Lee, Jeollabuk-do (KR); Woo Seop Song, Jeollabuk-do (KR); Chang Min Cho, Jeollabuk-do (KR); Seul Ki Choi, Jeollabuk-do (KR); Se Man Kwon, Jeollabuk-do (KR)

(21) Appl. No.: 18/974,355

(22) Filed: Dec. 9, 2024

(30) Foreign Application Priority Data
Jun. 3, 2024 (KR) 10-2024-0072183

(51) Int. Cl. H01M 4/36; C01B 17/20; H01M 4/02; H01M 10/0525; H01M 10/0562

(52) U.S. Cl. CPC H01M 4/366; C01B 17/20; H01M 10/0525; H01M 10/0562; C01P 2002/70; C01P 2004/61; H01M 2004/028; H01M 2300/0068

(57) ABSTRACT

Provided are a composite cathode active material for lithium secondary batteries with excellent coating quality and a method of preparing the same. The composite cathode active material comprises a core portion of a lithium transition metal compound and a shell portion of a sulfide-based solid electrolyte with a cohesive index between about 37 and 46. The shell constitutes about 2% to 10% by weight of the composite, with a thickness of about 50 nm to 500 nm and a planar density of about 0.05 mg/cm² to 0.3 mg/cm², determined by X-ray fluorescence spectrometry. The preparation method includes coating the core with the sulfide-based solid electrolyte through controlled mixing, stirring, and heat treatment, ensuring uniform and consistent coating quality. This composite material enhances the performance of lithium secondary batteries by improving the cathode's stability, ion conductivity, and overall electrochemical properties.

### CROSS-REFERENCE TO RELATED APPLICATION

This application claims, under 35 U.S.C. § 119 (a), the benefit of Korean Patent Application No. 10-2024-0072183, filed on Jun. 3, 2024, the entire contents of which are incorporated herein by reference.

### BACKGROUND

### Technical Field

The present disclosure relates to a composite cathode active material for lithium secondary batteries with excellent coating quality and a method of preparing the same. The material includes a core of lithium transition metal compound and a shell of sulfide-based solid electrolyte, optimized for stability and conductivity. The disclosed method involves precise mixing, stirring, and heat treatment to ensure uniform coating, enhancing battery performance and efficiency for applications in electric vehicles and portable electronics.

### Background

Secondary batteries, capable of repeated charging and discharging, are widely used in various applications, ranging from small electronic devices such as mobile phones and laptops to large transportation vehicles such as hybrid cars and electric cars. As the demand for these applications grows, there is an increasing need to develop secondary batteries with enhanced stability and higher energy density.

Most conventional secondary batteries have cells based on organic solvents (organic liquid electrolytes) and thus have limitations in improving stability and energy density.

Meanwhile, all-solid-state batteries using inorganic solid electrolytes are receiving great attention due to their safety and simplicity. By eliminating organic solvents, these batteries offer a safer alternative, allowing for the production of cells with enhanced stability and performance in a more straightforward manner.

All-solid-state batteries using sulfide-based solid electrolytes can experience deteriorated cell characteristics due to interfacial reaction between the sulfide-based solid electrolyte and the cathode active material. To address this issue, the surface of the cathode active material is typically coated with a stable material. However, most existing studies have focused primarily on the reactivity of the cathode active material and the sulfide-based solid electrolyte, often overlooking the critical factors of resistance and reaction rate between them, which significantly impact the actual performance and operation of the batteries.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art and it is one object of the present disclosure to provide a composite cathode active material for a lithium secondary battery that expands the passage of lithium ions from a cathode active material to a sulfide-based solid electrolyte to reduce the resistance between the two materials and a method of preparing the same.

It is another object of the present disclosure to provide a composite cathode active material for a lithium secondary battery having a uniform coating layer by coating a cathode active material with a sulfide-based solid electrolyte having weak cohesion to prevent aggregation of the sulfide-based solid electrolyte and a method for preparing the same.

It is another object of the present disclosure to provide a novel analysis parameter that is capable of identifying and analyzing a coating layer containing a sulfide-based solid electrolyte in 3 dimensions based on X-ray fluorescence analysis.

The objects of the present disclosure are not limited to those described above. Other objects of the present disclosure will be clearly understood from the following description, and are able to be implemented by means defined in the claims and combinations thereof.

In one aspect, the present disclosure provides a composite cathode active material for a lithium secondary battery including a core portion containing a lithium transition metal compound, and a shell portion containing a sulfide-based solid electrolyte, wherein the sulfide-based solid electrolyte has a cohesive index of not lower than about 37 and lower than about 46.

The composite cathode active material may include 90% to 98% by weight of the core portion and 2% to 10% by weight of the shell portion. In other words, the core portion constitutes about 90% to 98% by weight of the composite active material; and the shell portion constitutes about 2% to 10% by weight of the composite cathode active material.

A thickness of the shell portion determined by irradiating X-rays to the composite cathode active material through X-ray fluorescence spectrometry (XRF) and measuring the intensity of X-rays derived from a sulfur element released from the composite cathode active material in response to the X-rays may be about 50 nm to 500 nm.

The thickness of the shell portion may be determined by irradiating X-rays to a plurality of measurement spots of the composite cathode active material and measuring the intensity of X-rays derived from the sulfur element.

A planar density of the shell portion determined by irradiating X-rays to the composite cathode active material through X-ray fluorescence spectrometry (XRF) and measuring the intensity of X-rays derived from a sulfur element released from the composite cathode active material in response to the X-rays may be about 0.05 mg/cm² to 0.3 mg/cm².

The planar density of the shell portion may be determined by irradiating X-rays to a plurality of measurement spots of the composite cathode active material and measuring the intensity of X-rays derived from the sulfur element.

In another aspect, the present disclosure provides a method of preparing a composite cathode active material including preparing a sulfide-based solid electrolyte, and coating a lithium transition metal compound with the sulfide-based solid electrolyte to obtain a composite cathode active material including a core portion containing a lithium transition metal compound and a shell portion containing a sulfide-based solid electrolyte, wherein the sulfide-based solid electrolyte has a cohesive index of not lower than about 37 and lower than about 46.

The preparing the sulfide-based solid electrolyte may include preparing a starting material, reacting the starting material to obtain an intermediate material, and heat-treating the intermediate material to obtain a sulfide-based solid electrolyte.

The sulfide-based solid electrolyte may have an average particle diameter (D50) of about 2 μm or less.

The preparing the sulfide-based solid electrolyte may include heat treating the intermediate material at a temperature of higher than about 400° C. and lower than about 500° C.

The preparing the composite cathode active material may include mixing the sulfide-based solid electrolyte with a lithium transition metal compound at a first rate to obtaining a mixture, stirring the mixture at a second rate higher than the first rate to disperse the mixture, and stirring the dispersed mixture at a third rate higher than the second rate to coat the lithium transition metal compound with the sulfide-based solid electrolyte.

The third rate may be about 2,000 rpm to 4,000 rpm.

The lithium transition metal compound may be coated with the sulfide-based solid electrolyte by stirring the dispersed mixture at the third rate for a period of longer than about 10 minutes and not longer than about 30 minutes.

Other aspects and preferred embodiments of the disclosure are discussed infra.

Also provided is a composite cathode active material for a lithium secondary battery, the composite cathode active material comprising: a core portion comprising a lithium transition metal compound; and a shell portion comprising a sulfide-based solid electrolyte. The sulfide-based solid electrolyte has a cohesive index of about 40 to 45. The core portion constitutes about 90% to 98% by weight of the composite cathode active material; and the shell portion constitutes about 2% to 10% by weight of the composite cathode active material. A thickness of the shell portion may be about 50 nm to 500 nm, and a planar density of the shell portion may be about 0.05 mg/cm² to 0.3 mg/cm².

As discussed, the method and system suitably include use of a controller or processer.

Also provide is a cathode layer for a lithium secondary battery comprising the aforementioned composite cathode active material.

A lithium secondary battery comprising the aforementioned cathode layer.

In another embodiment, vehicles are provided that comprise an apparatus as disclosed herein.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 shows a lithium secondary battery according to the present disclosure;

FIG. 2 shows an anode layer according to the present disclosure;

FIG. 3 shows a composite cathode active material according to a first embodiment of the present disclosure;

FIG. 4 shows a composite cathode active material according to a second embodiment of the present disclosure;

FIG. 5 shows an exemplary device for measuring the flow angle;

FIG. 6 shows a reference diagram for illustrating a method for measuring the flow angle;

FIG. 7 shows a reference diagram for illustrating the X-ray fluorescence spectrometry performed in the present disclosure;

FIG. 8A shows the result of scanning electron microscopy of the composite cathode active material according to Example 1;

FIG. 8B shows the result of energy dispersive X-ray spectroscopy of the composite cathode active material according to Example 1;

FIG. 9A shows the result of scanning electron microscopy of the composite cathode active material according to Comparative Example 1;

FIG. 9B shows the result of energy dispersive X-ray spectroscopy of the composite cathode active material according to Comparative Example 1;

FIG. 10A shows the result of scanning electron microscopy of the composite cathode active material according to Comparative Example 2;

FIG. 10B shows the result of energy dispersive X-ray spectroscopy of the composite cathode active material according to Comparative Example 2;

FIG. 11A shows the result of scanning electron microscopy of the composite cathode active material according to Comparative Example 3;

FIG. 11B shows the result of energy dispersive X-ray spectroscopy of the composite cathode active material according to Comparative Example 3;

FIG. 12 shows the results of measurement of the capacity retention rate of lithium secondary batteries containing the composite cathode active materials of Example 2, Example 3, Comparative Example 4, and Comparative Example 5;

FIG. 13 shows the result of X-ray fluorescence spectrometry of the composite cathode active material according to Example 3;

FIG. 14 shows the result of X-ray fluorescence spectrometry of the composite cathode active material according to Example 4;

FIG. 15 shows the result of X-ray fluorescence spectrometry of the composite cathode active material according to Example 6;

FIG. 16 shows the result of X-ray fluorescence spectrometry of the composite cathode active material according to Comparative Example 6;

FIG. 17 shows the measured thickness and planar density of the shell portions of the composite cathode active materials according to Examples 3 to 6; and

FIG. 18 shows the capacity retention rates of lithium secondary batteries containing composite cathode active materials according to Examples 3 to 6 and Comparative Example 6.

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed contents and to sufficiently inform those skilled in the art of the technical concept of the present disclosure.

A term “all-solid-state battery” as used herein refers to a rechargeable secondary battery that includes an electrolyte in a solid state which may include other electrolytic components for transferring ions between the electrodes of the battery.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined.

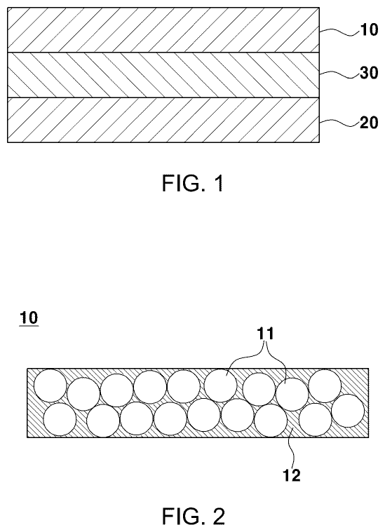

FIG. 1 shows a lithium secondary battery according to the present disclosure. The lithium secondary battery may include a cathode layer 10, an anode layer 20, and a solid electrolyte layer 30 located between the cathode layer 10 and the anode layer 20.

FIG. 2 shows the anode layer 10 according to the present disclosure. The cathode layer 10 may contain a composite cathode active material 11 and a cathode material 12. The cathode material 12 may contain a solid electrolyte, a binder, a conductive material, a dispersant, or the like.

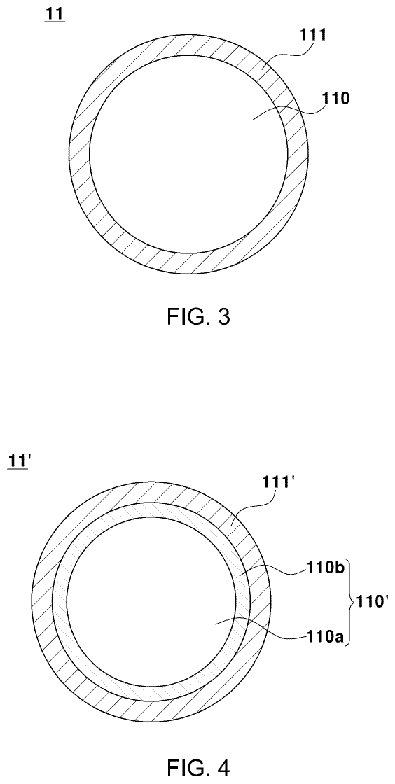

FIG. 3 shows the composite cathode active material 11 according to a first embodiment of the present disclosure. The composite cathode active material 11 may include a core portion 110 and a shell portion 111 coating an outer surface of the core portion 110.

The shell portion 111 may cover about 10% or more, about 20% or more, about 30% or more, about 40% or more, about 50% or more, about 60% or more, about 70% or more, about 80% or more, about 90% or more, or about 99% or more of the surface of the core portion 110.

The core portion 110 may contain a lithium transition metal compound capable of intercalating and deintercalating lithium ions.

The lithium transition metal oxide may include any ordinary electrolyte that is used in the technical field to which the present disclosure pertains. For example, the lithium transition metal oxide may include LiNiₓ₁Co_{X2}Mn_{X3}O₂ (0.65≤x1≤0.85, 0.05<x2<0.25, 0.03<x3<0.2, and x1+x2+x3=1).

The core portion 110 may be in the form of a secondary particle in which primary particles containing the lithium transition metal oxide aggregate. The primary particle may refer to the smallest particle unit that is distinguished as one lump when the cross-section of the core portion 110 is observed through equipment such as a scanning electron microscope (SEM). The primary particle may be formed in the form of a single grain or a plurality of grains. The secondary particle may refer to a structure in which a plurality of primary particles aggregates. The shape of the secondary particle is not particularly limited and may be, for example, spherical or oval.

The average particle diameter (D50) of the core portion 110 is not particularly limited and may be, for example, 1 μm to 20 μm. The average particle diameter (D50) of the core portion 110 may be measured using a commercially available laser diffraction scattering-type particle size distribution meter, for example, a Microtrac particle size distribution meter. In addition, 200 particles may be randomly extracted from an electron microscope and the average particle diameter thereof may be calculated.

The shell portion 111 may contain a sulfide-based solid electrolyte.

The sulfide-based solid electrolyte may contain any ordinary electrolyte that is used in the technical field to which the present disclosure pertains. For example, the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is Ge, Zn, or Ga), Li₂S—GeS₂, Li₂S—SiS₂—Li₃PO₄, Li₂S—SiS₂-LiₓMO_{y} (wherein x and y are positive numbers and M is P, Si, Ge, B, Al, Ga, or In), Li₁₀GeP₂S₁₂ or the like. In addition, preferably, the sulfide-based solid electrolyte may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (wherein Ha includes Cl, Br or I, and y satisfies 0<y≤2), Li_{7-z}PS_{6-z}(Ha1_{1-b}Ha2_{b})_{z} (Ha1 and Ha2 are different from each other and each independently include Cl, Br or I, and b and z satisfy 0<b<1 and 0<z≤2, respectively), and combinations thereof.

FIG. 4 shows a composite cathode active material 11′ according to a second embodiment of the present disclosure. The composite cathode active material 11′ may include a core portion 110′ and a shell portion 111′ coating an outer surface of the core portion 110′.

The core portion 110′ may include a central portion 110a containing a lithium transition metal compound and a peripheral portion 110b coating the surface of the central portion. The central portion 110a is the same as the core portion 110 of the first embodiment and thus detailed description thereof will be omitted below.

The peripheral portion 110b may contain an inorganic compound. The inorganic compound may include at least one selected from the group consisting of LiNbO₃, LizZrO₃, Li₃PO₄, Li₂SiO₃, and combinations thereof.

The shell portion 111′ is the same as the shell portion 111 of the first embodiment and thus detailed description thereof will be omitted below.

The present disclosure is characterized by using a compound with lower cohesive force than a conventional sulfide-based solid electrolyte constituting the shell portion 111. The conventional sulfide-based solid electrolyte has strong inter-particle cohesion and thus forms an aggregate during the production process of the shell portion 11. Accordingly, the shell portion 111 is not formed properly and the electrochemical properties are deteriorated due to increased resistance caused by the aggregate in the cathode layer 10.

The present disclosure is characterized in that the shell portion 111 is formed using a sulfide-based solid electrolyte having a cohesive index of not lower than about 37 and lower than about 46, or of about 40 to 45.

The cohesive index is an index of the cohesion between particles of the powder while the powder is flowing. As the cohesive index decreases, the dispersibility increases.

The cohesive index may be calculated using the flow angle and the change in the interface between the air and the powder rotating at a predetermined rate in the drum.

The flow angle is a parameter indicating the fluidity of powder. The term “fluidity” refers to the ability of the powder to flow freely and uniformly in the form of each particle. As flow angle decreases, the force of attraction between particles decreases and the fluidity of the powder increases.

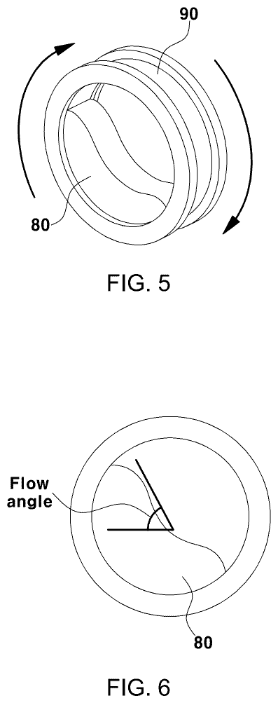

FIG. 5 shows an exemplary device for measuring the flow angle. First, a predetermined amount of powder 80 is injected into a cylindrical drum 90. The drum 90 rotates at a constant rate and as the drum 90 rotates, a layer of powder 80 is pulled upward. Then, an avalanche occurs when the balance between the attraction between particles of the powder 80 and gravity is lost. The avalanche occurring periodically in the rotating drum 90 is continuously imaged with a digital camera (800×800 pixel). The image is analyzed for measurement of the flow angle. The angle of the slope of the layer of the powder 80 to the ground when an avalanche occurs may be determined as the flow angle, as shown in FIG. 6. The device for measuring the flow angle may be, for example, a GranuDruM™ powder rheometer, and the results may be analyzed with GranuTools™ software.

The rotation rate of the drum 90 is not particularly limited and, for example, the drum 90 may rotate at about 1 rpm to 70 rpm.

In addition, the digital camera may image the powder 80 at intervals of about 500 ms to 1,000 ms.

From the imaged results, the average of the interface of the powder 80 and the air within the drum 90 excluding the powder 80 is calculated and then the standard deviation (σ(x)) of the average is calculated in pixel units. The cohesive index may be obtained by summing all the values calculated in pixel units, calculating an average and indexing the result to obtain a cohesive index. Specifically, the standard deviation and cohesive index may be calculated in accordance with the following equation and more details can be seen from Powder Technology, 224 (2012) 19-27.

$$σ ( x ) = √ \frac{{\sum }_{i = 0}^{{N}_{y} ( x )} {( \overline{y} ( x ) - {y}_{i} ( x ) )}^{2}}{{N}_{y} ( x )} \\ Cohesive Index ( C I ) = \frac{1}{Dcrop} {\sum }_{x} σ ( x )$$

N_{y}(x) is the number of y-axis coordinates corresponding to the x-axis of the average interface.
σ(x) is the standard deviation of the x-axis coordinate.
\tilde{y}(x) is the x-axis coordinate of the average interface.
yᵢ(x) is the y-axis coordinate corresponding to the x-axis of the average interface.
N is the number of images.
nᵢ is the number of pixels at the interface between the cathode active material and air.
   References herein to “cohesive index” are intended to mean values of a material as determined as set forth above, i.e. by the procedure set forth in FIG. 5 and described above and by the above equation. When the sulfide-based solid electrolyte according to the present disclosure is injected into a drum 90 rotating at about 10 rpm and imaged 50 times at intervals of 1,000 ms using a digital camera, the cohesive index of the sulfide-based solid electrolyte calculated using the average acting as a basis of the flow angle and deviation of changes in the interface between the air and the sulfide-based solid electrolyte may be not lower than about 37 and lower than about 46, or about 40 to 45. When the cohesive index of the sulfide-based solid electrolyte is less than 37, the sulfide-based solid electrolyte does not form the shell portion 111 and remains as an aggregate, which may increase the grain boundary resistance in the anode layer 10. In order for the cohesive index of the sulfide-based solid electrolyte to be 46 or more, the temperature of heat treatment must be high, as will be described later. As a result, the crystallinity of the sulfide-based solid electrolyte increases, which may result in increased resistance in the anode layer 10 and reduced efficiency.

The method of preparing a sulfide-based solid electrolyte having a low cohesive index and a composite cathode active material containing the same according to the present disclosure will be described in detail below.

The method may include preparing a sulfide-based solid electrolyte and coating a lithium transition metal compound with the sulfide-based solid electrolyte to obtain a composite cathode active material.

The preparing the sulfide-based solid electrolyte may include preparing a starting material, reacting the starting material to obtain an intermediate material, and heat-treating the intermediate material to obtain a sulfide-based solid electrolyte.

The type of the starting material is not particularly limited and the starting material may, for example, be a lithium source, a phosphorus source, a halogen compound, or the like.

The lithium source may include Li₂S, Li₂S₂, Li₂S₄, Li₂S₈, elemental lithium, or the like. The phosphorus source may include P₂S₃, P₂S₅, elemental phosphorus, or the like. The halogen compound may include LiCl, LiBr, LiI, or the like. The starting material may further include elemental sulfur and a compound of the substitution element or doping element.

The content of each starting material may be appropriately adjusted to suit the composition of the desired sulfide-based solid electrolyte.

The method of reacting the starting material is not particularly limited. The intermediate material may be obtained by reacting the starting material using a dry and/or wet method. For example, the dry method involves injecting the starting material and balls into a container and applying energy to the starting material while rotating. The wet method involves injecting a starting material and a polar solvent such as tetrahydrofuran or acetonitrile capable of dissolving the starting material into a container, and applying energy to the starting material through stirring. When the intermediate material is prepared by a wet method, drying may be further performed to remove the remaining polar solvent before heat treatment.

The present disclosure is characterized by heat-treating the intermediate material at a specific temperature to obtain a sulfide-based solid electrolyte having a low cohesive index. The heat treatment may be a process of converting the intermediate material into a sulfide-based solid electrolyte having an intact crystal structure. The preparing the sulfide-based solid electrolyte may include heat treating the intermediate material at a temperature of higher than about 400° C. and lower than about 500° C. When the temperature of the heat treatment is 400° C. or lower, the crystal structure of the sulfide-based solid electrolyte may not be properly formed and lithium ion conductivity may decrease, and when the temperature of the heat treatment is higher than 500° C., the cohesive index of the sulfide-based solid electrolyte may increase.

The step of preparing the sulfide-based solid electrolyte may further include grinding the sulfide-based solid electrolyte obtained as above. As a result, it is possible to obtain a sulfide-based solid electrolyte with an average particle diameter (D50) of about 2 μm or less. When the average particle diameter (D50) of the sulfide-based solid electrolyte exceeds 2 μm, the shell portion 111 may be not uniformly formed using the sulfide-based solid electrolyte.

The preparing the composite cathode active material includes mixing the sulfide-based solid electrolyte with a lithium transition metal compound at a first rate to obtaining a mixture, stirring the mixture at a second rate higher than the first rate to perform dispersion, and stirring the dispersed mixture at a third rate higher than the second rate to coat the lithium transition metal compound with the sulfide-based solid electrolyte.

For example, the mixture may be obtained by injecting the sulfide-based solid electrolyte and the lithium transition metal compound into a container such as a miller and mixing at a rate of about 300 rpm to 700 rpm, or about 500 rpm. Then, the mixture may be stirred at a rate of about 1,200 rpm to 1,800 rpm, or about 1,500 rpm to increase dispersibility. Finally, the lithium transition metal compound may be coated with the sulfide-based solid electrolyte while stirring the dispersed mixture at about 2,000 rpm to 4,000 rpm or about 3,000 rpm for a period of longer than about 10 minutes and shorter than about 30 minutes.

When the mixing time at the third rate is less than 10 minutes, the coverage ratio of the shell portion 111 may decrease and the desired performance improvement may not be achieved.

The composite cathode active material 11 according to the present disclosure may contain about 90% to 98% by weight of the core portion 110 and about 2% to 10% by weight of the shell portion 111. When the content of the shell portion 111 is less than 2% by weight, the shell portion 111 may be too thin to obtain the effect of introducing the shell portion 111, and when the content exceeds 10% by weight, the shell portion 111 may be non-uniformly formed.

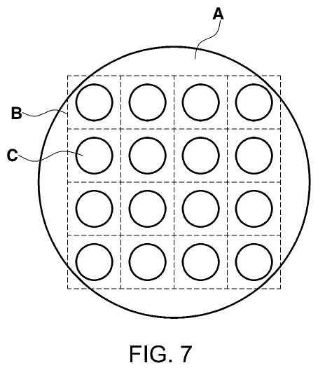

The thickness of the shell portion 111 may be about 50 nm to 500 nm. The thickness of the shell portion 111 is measured by irradiating X-rays to the composite cathode active material 11 through X-ray fluorescence spectrometry (XRF) and measuring the intensity of X-rays derived from the sulfur atoms released from the composite cathode active material 11 in response to the X-rays. FIG. 7 shows a reference diagram for illustrating the X-ray fluorescence spectrometry performed in the present disclosure. As shown in FIG. 7, the sample A may be divided into a plurality of measurement sections B, and X-rays may be irradiated to measurement spots C of measurement sections B. The thickness of the shell portion 111 may be calculated by measuring the intensity of X-rays derived from sulfur atoms released from the measurement spots C. In addition, the planar density of the shell portion 111 may be about 0.05 mg/cm² to 0.3 mg/cm². The planar density may be measured and calculated in the same manner as in the thickness. According to the present disclosure, the 3D shape of the composite cathode active material 11 can be seen because X-rays are irradiated to a plurality of measurement spots C as described above and the intensity of the X-rays emitted from the measurement spots C is measured.

Hereinafter, the present disclosure will be described in more detail with reference to the following examples. However, these examples are provided only for better understanding and should not be construed as limiting the scope of the present disclosure.

### Example 1 and Comparative Examples 1 to 3

Starting materials, such as Li₂S and P₂S₅, are prepared at equal amounts and injected into a container and stirred to induce a reaction to obtain an intermediate material. The intermediate material was heat-treated under the temperature conditions shown in Table 1 below to obtain sulfide-based solid electrolytes in accordance with Example 1 and Comparative Examples 1 to 3. The cohesive index and average particle size (D50) of each sulfide-based solid electrolyte are shown in Table 1.

Each sulfide-based solid electrolyte was mixed with lithium transition metal oxide at a rate of about 500 rpm to obtain a mixture, the mixture was stirred and dispersed at a rate of about 1,500 rpm, and the dispersed mixture was stirred at about 3,000 rpm for 20 minutes to form a composite cathode active material containing a core portion and a shell portion. Each composite cathode active material contained about 2% by weight of the shell portion.

A lithium secondary battery was manufactured using each composite cathode active material, and the initial efficiency, initial charge capacity, and discharge capacity of the lithium secondary battery were measured and are shown in Table 1 below.

TABLE 1

| | | | | | 1^{st} | | | | |
|---|---|---|---|---|---|---|---|---|---|
| | Heat | | | Initial | charge | | | | |
| | treatment | Cohesive | | efficiency | capacity | Discharge capacity [mAh/g] | | | |
| Item | temperature | index | D50 | [%] | [mAh/g] | 0.1 C | 0.33 C | 0.5 C | 1 C |
| Comparative | 400° C. | 46.0 | 0.94 | 88.3 | 224.2 | 201.4 | 167.2 | 155.8 | 139.6 |
| Example 1 | | | μm | | | | | | |
| Example 1 | 450° C. | 42.6 | 0.32 | 92.2 | 224.4 | 205.7 | 175.9 | 161.6 | 146.4 |
| | | | μm | | | | | | |
| Comparative | 500° C. | 46.5 | 2.01 | 89.1 | 223.6 | 199.4 | 172.2 | 159.8 | 143.1 |
| Example 2 | | | μm | | | | | | |
| Comparative | 550° C. | 36.9 | 3.52 | 87.4 | 220.0 | 192.3 | 169.8 | 156.4 | 139.9 |
| Example 3 | | | μm | | | | | | |

As can be seen from Table 1, the sulfide-based solid electrolyte of Example 1, which is heat treated at a temperature higher than 400° C. and lower than 500° C., has a cohesive index of not less than 37 and less than 46, and an average particle diameter (D50) of 2 μm. All of the initial efficiency, the first charge capacity, and the discharge capacity of the lithium secondary battery according to Example 1 are higher than those of Comparative Examples 1 to 3. Comparative Examples 1 and 2 have a cohesion index of 46 or more and similar 1^{st} charge capacity to Example 1, but low initial efficiency and discharge capacity. In particular, Comparative Example 2 exhibits increased crystallinity of the sulfide-based solid electrolyte due to the high heat treatment temperature and thus high resistance in the electrode and slightly low initial efficiency. Comparative Example 3 has a cohesive index of less than 37 and the highest heat treatment temperature. Accordingly, the sulfide-based solid electrolyte of Comparative Example 3 has excessively high crystallinity, making it difficult to form a shell portion, and the residual sulfide-based solid electrolyte remains as an aggregate, resulting in high grain boundary resistance and poor electrochemical performance.

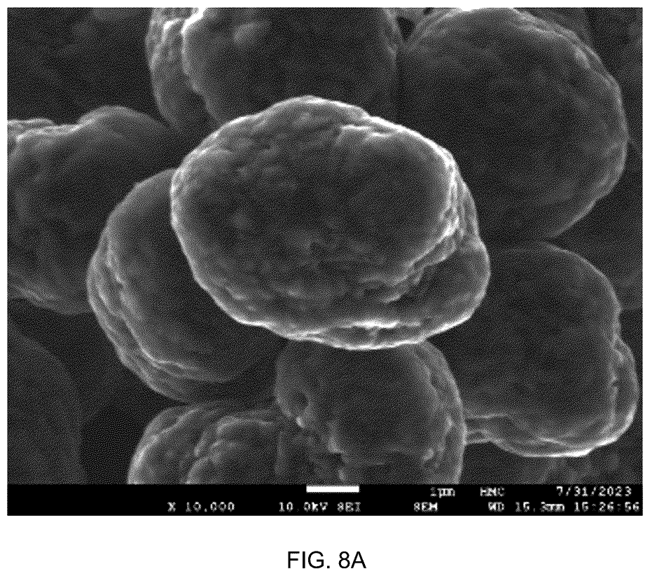

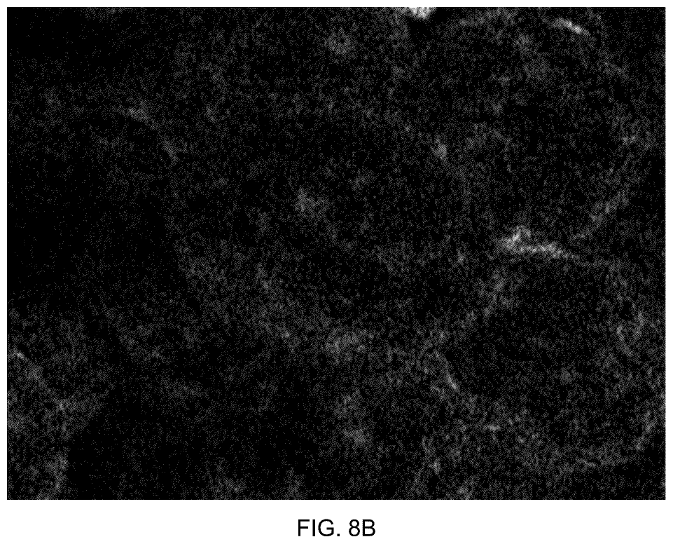

FIG. 8A shows the result of scanning electron microscopy of the composite cathode active material according to Example 1. FIG. 8B shows the result of energy dispersive X-ray spectroscopy of the composite cathode active material according to Example 1. In the composite cathode active material according to Example 1, the sulfide-based solid electrolyte does not aggregate and forms a uniform shell portion.

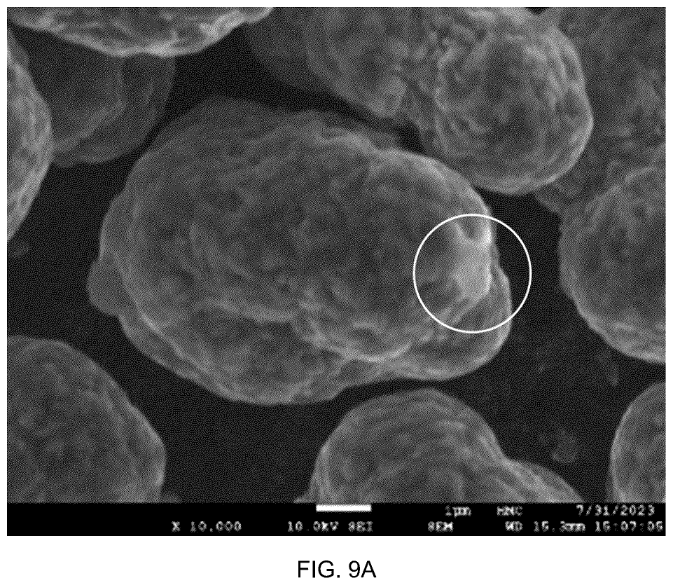

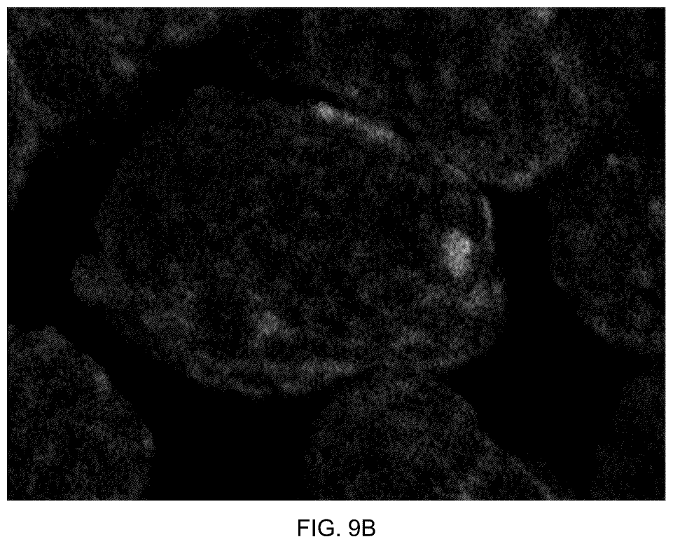

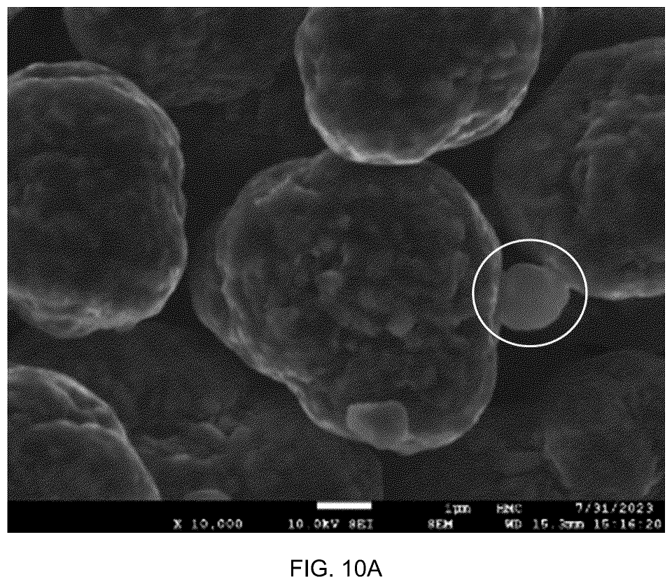

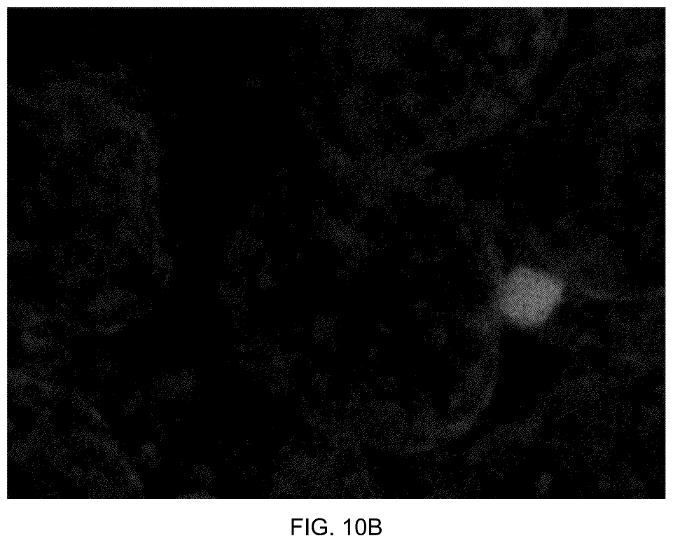

FIG. 9A shows the result of scanning electron microscopy of the composite cathode active material according to Comparative Example 1. FIG. 9B shows the result of energy dispersive X-ray spectroscopy of the composite cathode active material according to Comparative Example 1. FIG. 10A shows the result of scanning electron microscopy of the composite cathode active material according to Comparative Example 2. FIG. 10B shows the result of energy dispersive X-ray spectroscopy of the composite cathode active material according to Comparative Example 2. In the composite cathode active materials according to Comparative Examples 1 and 2, the sulfide-based solid electrolyte does not aggregate, but particle size control and shell portion formation are difficult due to high crystallinity.

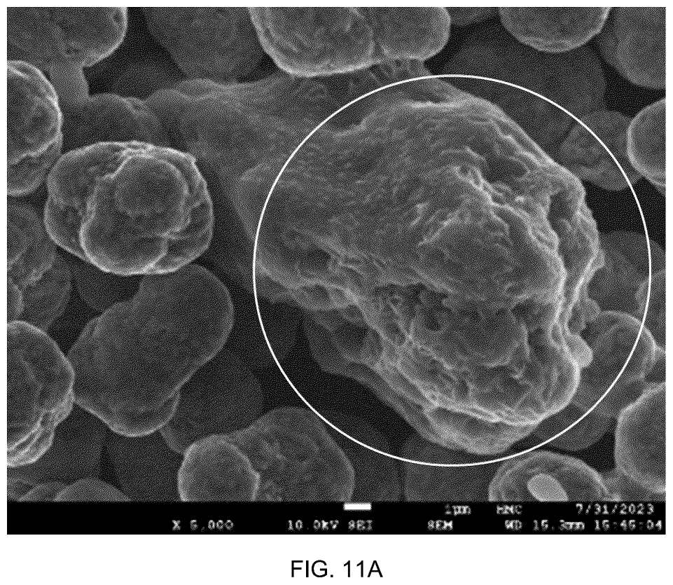

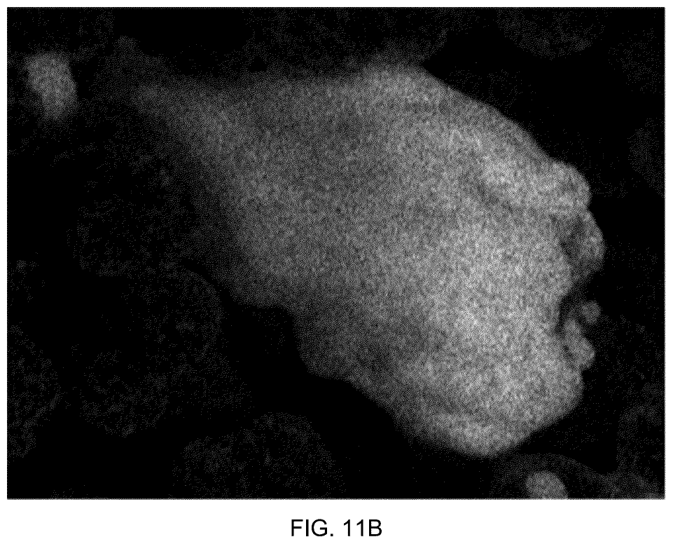

FIG. 11A shows the result of scanning electron microscopy of the composite cathode active material according to Comparative Example 3. FIG. 11B shows the result of energy dispersive X-ray spectroscopy of the composite cathode active material according to Comparative Example 3. It can be seen that the sulfide-based solid electrolyte aggregates in the composite cathode active material according to Comparative Example 3.

### Examples 2 and 3, and Comparative Examples 4 and 5

Each sulfide-based solid electrolyte prepared in Example 1 was mixed with lithium transition metal oxide at a rate of about 500 rpm to obtain a mixture, the mixture was stirred and dispersed at a rate of about 1,500 rpm, and the dispersed mixture was stirred at about 3,000 rpm for 10 minutes (Comparative Example 4), 20 minutes (Example 2) and 30 minutes (Example 3) to form composite cathode active materials, each containing a core portion and a shell portion. Each composite cathode active material contained about 2% by weight of the shell portion.

Separately, a composite cathode active material was prepared in a lab-scale at the same rate for the same time as in Comparative Example 4 and this was defined as Comparative Example 5.

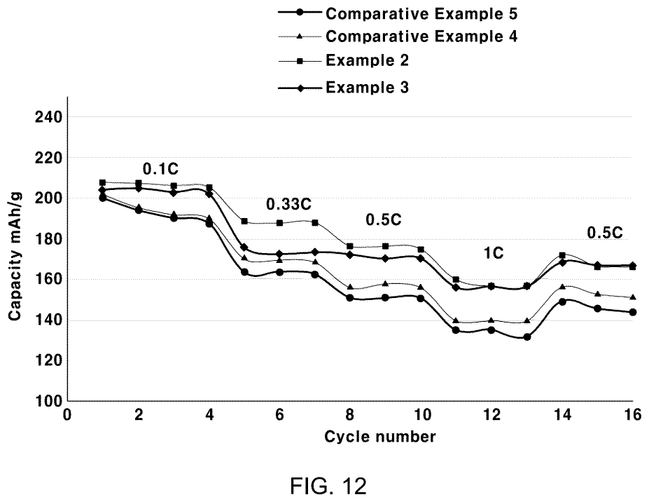

FIG. 12 shows the results of measurement of the capacity retention rate of lithium secondary batteries containing the composite cathode active materials of Example 2, Example 3, Comparative Example 4, and Comparative Example 5. Measurement conditions are approximately 30° C. and 2.5V to 4.35V.

In Comparative Examples 4 and 5, the core portion cannot be completely covered with the shell portion due to excessively short coating holding time and thus the core portion is formed partially. Examples 2 and 3 have improved battery output characteristics compared to Comparative Examples 4 and 5.

### Examples 3 to 6 and Comparative Example 6

A composite cathode active material was prepared in the same manner as in Example 2, except that the content of the shell portion was changed to 2% by weight (Example 3), 5% by weight (Example 4), 7% by weight (Example 5), and 10% by weight (Example 6) and 20% by weight (Comparative Example 6).

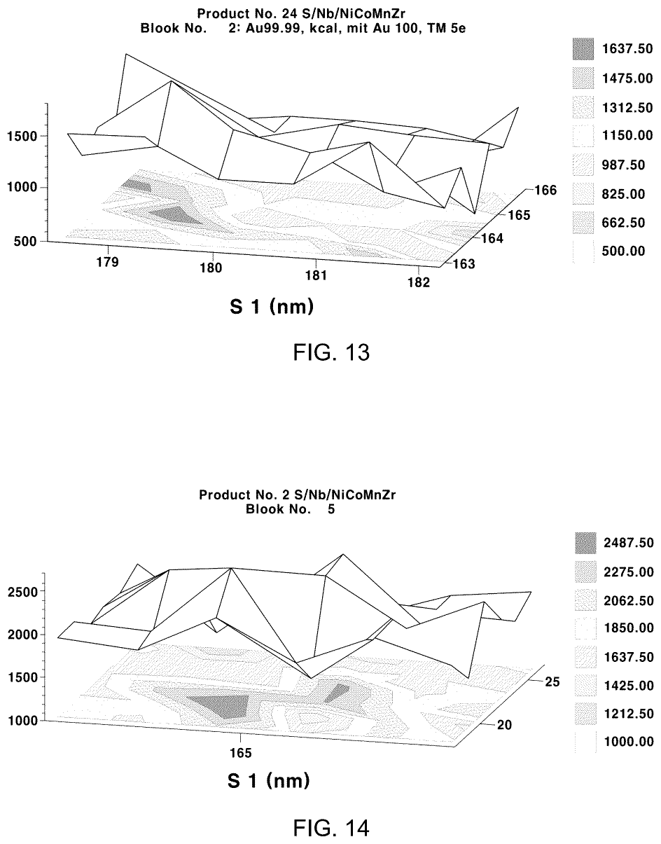

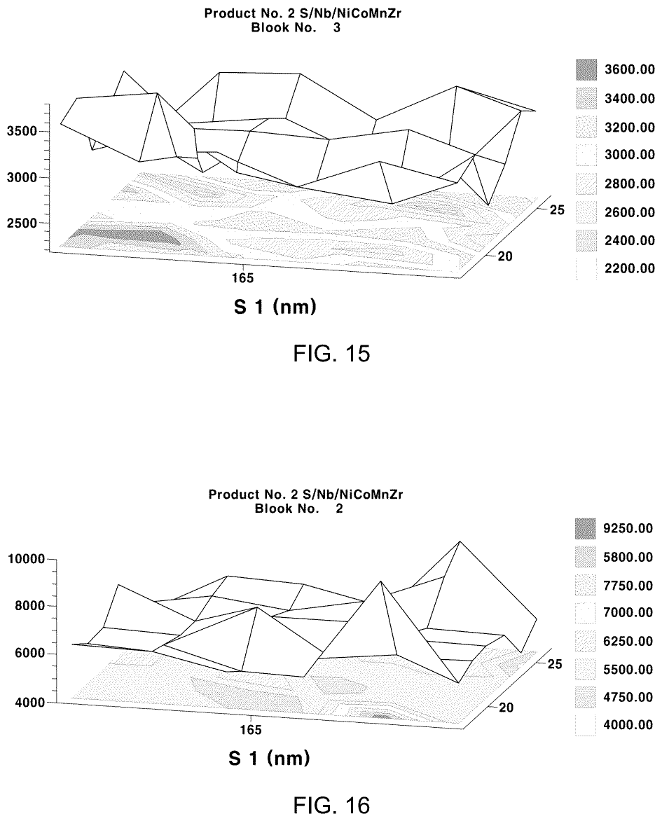

FIG. 13 shows the result of X-ray fluorescence spectrometry of the composite cathode active material according to Example 3. FIG. 14 shows the result of X-ray fluorescence spectrometry of the composite cathode active material according to Example 4. FIG. 15 shows the result of X-ray fluorescence spectrometry of the composite cathode active material according to Example 6. FIG. 16 shows the result of X-ray fluorescence spectrometry of the composite cathode active material according to Comparative Example 6. In this way, the 3D shape of the composite cathode active material can be seen by irradiating X-rays to the composite cathode active material 11 and measuring the intensity of X-rays derived from sulfur atoms released from the composite cathode active material.

As can be seen from FIG. 16, when an excessive amount of sulfide-based solid electrolyte is added as in Comparative Example 6, the coating state is partially uneven.

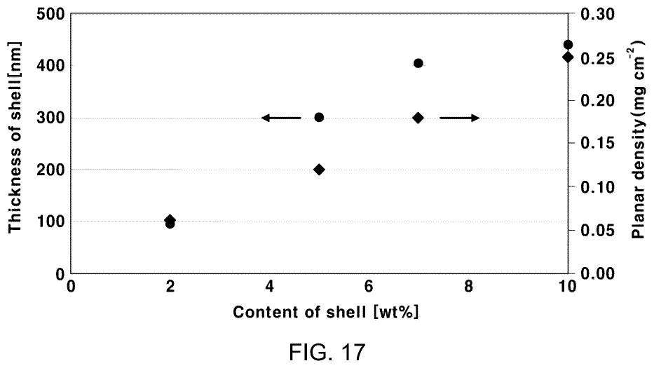

FIG. 17 shows the measured thickness and planar density of the shell portions of the composite cathode active materials according to Examples 3 to 6. The thickness and area density increase linearly as the content of the shell portion increases, which indicates that no aggregates are formed and that all of the added sulfide-based solid electrolyte constitutes the shell portion.

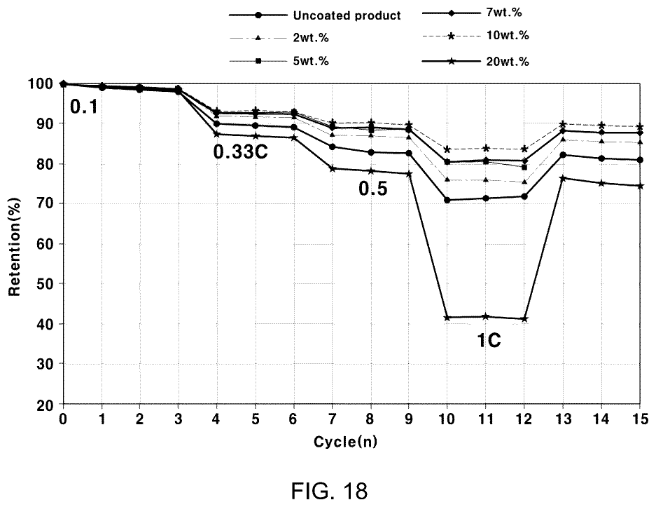

FIG. 18 shows the capacity retention rate of lithium secondary batteries containing composite cathode active materials according to Examples 3 to 6 and Comparative Example 6. The results of Examples 3 to 6 show that the discharge capacity and capacity maintenance rate increase as the content of the shell portion increases. However, as in Comparative Example 6, when the content of the shell portion exceeds 10% by weight, the sulfide-based solid electrolyte that remains without being involved in the coating forms an aggregate, thus increasing the grain boundary resistance, reducing the reaction rate in the electrode, which determines the overall reaction rate of the battery, and reducing the rate characteristics.

According to the present disclosure, it is possible to obtain a composite cathode active material for a lithium secondary battery that can reduce the resistance between the two materials by expanding the passage of lithium ions from the cathode active material to the sulfide-based solid electrolyte and a method of manufacturing the same.

According to the present disclosure, it is possible to obtain a composite cathode active material for a lithium secondary battery having a uniform coating layer by coating a cathode active material with a sulfide-based solid electrolyte with weak cohesion to prevent aggregation of the sulfide-based solid electrolyte, and a method of manufacturing the same.

According to the present disclosure, it is possible to obtain novel analysis parameters that can identify and analyze a coating layer containing a sulfide-based solid electrolyte in 3D form using X-ray fluorescence analysis.

According to the present disclosure, it is possible to obtain a sulfide-based solid electrolyte with appropriate cohesion and crystallinity suitable for coating by controlling the temperature of heat treatment when synthesizing the sulfide-based solid electrolyte.

According to the present disclosure, it is possible to obtain a composite cathode active material for a lithium secondary battery having a uniform coating layer by increasing the coating holding time in the process of coating a cathode active material with a sulfide-based solid electrolyte and a method of manufacturing the same.

According to the present disclosure, it is possible to obtain a composite cathode active material that has reduced resistance due to aggregates by preventing generation of aggregates such as by grinding the sulfide-based solid electrolyte that does not form a coating layer through changes in the conditions of the process of coating the cathode active material with the sulfide-based solid electrolyte and a method of manufacturing the same.

According to the present disclosure, it is possible to obtain a lithium secondary battery that can be rapidly charged by increasing the reaction rate in the cathode and a method of manufacturing the same.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

What is claimed is:

1. A composite cathode active material for a lithium secondary battery, the composite cathode active material comprising:
a core portion comprising a lithium transition metal compound; and
a shell portion comprising a sulfide-based solid electrolyte,
wherein the sulfide-based solid electrolyte has a cohesive index of not lower than about 37 and lower than about 46.

2. The composite cathode active material according to claim 1, wherein the composite cathode active material comprises:
90% to 98% by weight of the core portion; and 2% to 10% by weight of the shell portion.

3. The composite cathode active material according to claim 1, wherein a thickness of the shell portion determined by irradiating X-rays to the composite cathode active material through X-ray fluorescence spectrometry (XRF) and measuring the intensity of X-rays derived from a sulfur element released from the composite cathode active material in response to the X-rays is about 50 nm to 500 nm.

4. The composite cathode active material according to claim 1, wherein a planar density of the shell portion determined by irradiating X-rays to the composite cathode active material through X-ray fluorescence spectrometry (XRF) and measuring the intensity of X-rays derived from a sulfur element released from the composite cathode active material in response to the X-rays is about 0.05 mg/cm² to 0.3 mg/cm².

5. The composite cathode active material according to claim 1, wherein a thickness and a planar density of the shell portion are determined by irradiating X-rays to a plurality of measurement spots of the composite cathode active material and measuring the intensity of X-rays derived from the sulfur element.

6. A method of preparing a composite cathode active material comprising:
preparing a sulfide-based solid electrolyte; and
coating a lithium transition metal compound with the sulfide-based solid electrolyte to obtain a composite cathode active material comprising a core portion comprising a lithium transition metal compound and a shell portion comprising a sulfide-based solid electrolyte,
wherein the sulfide-based solid electrolyte has a cohesive index of not lower than about 37 and lower than about 46.

7. The method according to claim 6, wherein the preparing the sulfide-based solid electrolyte comprises:
preparing a starting material;
reacting the starting material to obtain an intermediate material; and
heat-treating the intermediate material to obtain a sulfide-based solid electrolyte.

8. The method according to claim 6, wherein the sulfide-based solid electrolyte has an average particle diameter (D50) of about 2 μm or less.

9. The method according to claim 7, wherein the preparing the sulfide-based solid electrolyte comprises heat treating the intermediate material at a temperature of higher than about 400° C. and lower than about 500° C.

10. The method according to claim 6, wherein the preparing the composite cathode active material comprises:
mixing the sulfide-based solid electrolyte with a lithium transition metal compound at a first rate to obtaining a mixture;
stirring the mixture at a second rate higher than the first rate to disperse the mixture; and
stirring dispersed mixture at a third rate higher than the second rate to coat the lithium transition metal compound with the sulfide-based solid electrolyte.

11. The method according to claim 10, wherein the third rate is about 2,000 rpm to 4,000 rpm.

12. The method according to claim 10, wherein the lithium transition metal compound is coated with the sulfide-based solid electrolyte by stirring dispersed mixture at the third rate for a period of longer than about 10 minutes and not longer than about 30 minutes.

13. The method according to claim 6, wherein the composite cathode active material comprises:
90% to 98% by weight of the core portion; and
2% to 10% by weight of the shell portion.

14. The method according to claim 6, wherein a thickness of the shell portion determined by irradiating X-rays to the composite cathode active material through X-ray fluorescence spectrometry (XRF) and measuring the intensity of X-rays derived from a sulfur element released from the composite cathode active material in response to the X-rays is about 50 nm to 500 nm.

15. The method according to claim 6, wherein a planar density of the shell portion determined by irradiating X-rays to the composite cathode active material through X-ray fluorescence spectrometry (XRF) and measuring the intensity of X-rays derived from a sulfur element released from the composite cathode active material in response to the X-rays is about 0.05 mg/cm² to 0.3 mg/cm².

16. The method according to claim 6, wherein a thickness and a planar density of the shell portion are determined by irradiating X-rays to a plurality of measurement spots of the composite cathode active material and measuring the intensity of X-rays derived from the sulfur element.

17. A composite cathode active material for a lithium secondary battery, the composite cathode active material comprising:
a core portion comprising a lithium transition metal compound; and
a shell portion comprising a sulfide-based solid electrolyte,
wherein the sulfide-based solid electrolyte has a cohesive index of about 40 to 45, and
wherein the core portion constitutes about 90% to 98% by weight of the composite cathode active material; and the shell portion constitutes about 2% to 10% by weight of the composite cathode active material.

18. The composite cathode active material according to claim 17, wherein a thickness of the shell portion is about 50 nm to 500 nm, and a planar density of the shell portion is about 0.05 mg/cm² to 0.3 mg/cm².

19. A cathode layer for a lithium secondary battery comprising the composite cathode active material of claim 1.

20. A lithium secondary battery comprising the cathode layer of claim 19.
